(19) United States
(12) Patent Application Publication
(10) Pub. No.: US 2017/0268291 A1
(43) Pub. Date: Sep. 21, 2017

(54) PULL CORD EQUALIZER BUCKLE FOR WINDOW BLIND

(71) Applicant: CHEN, Chin-Fu, Taichung City (TW)

(72) Inventor: Po-Yu CHEN, TAICHUNG CITY (TW)

(21) Appl. No.: 15/462,307

(22) Filed: Mar. 17, 2017

(30) Foreign Application Priority Data
Mar. 18, 2016 (TW) 105203804

(51) Int. Cl. E06B 9/326

(52) U.S. Cl. CPC E06B 9/326; E06B 2009/3265

(57) ABSTRACT

A pull cord equalizer buckle for window blind is disclosed to include two equalizer buckle members abutted against each other. Each equalizer buckle member includes a cord-escape hole and a cord-retaining slot at a bottom side relative to the cord-escape hole. Two pull cords are respectively inserted through the cord-escape holes of the two equalizer buckle members and retained by one respective cord-retaining slot. If the two pull cords are forced outwards by an external object, the pull cords will give an outward pressure to the close ends of the respective cord-escape holes, and these two equalizer buckle members will be forced apart and released from the pull cords if the pressure imparted by the pull cords is larger than the binding force between the two equalizer buckle members, ensuring application safety.

### BACKGROUND OF THE INVENTION

1. Field of the Invention

The present invention relates to window blind technology, and more particularly to a pull cord equalizer buckle for window blind that enhances operational safety.

2. Description of the Related Art

In order to facilitate the control of the opening and closing operations of a window blind, the pull cords of the window blind are normally exposed to the outside of the window blind for operation by the user, and a pull cord equalizer buckle is used to secure the outer ends of the pull cords, preventing the pull cords from getting tangled and keeping the pull cords in a good order.

However, because each pull cord is locked to the pull cord equalizer buckle, a hanging space is formed between the pull cords and the pull cord equalizer buckle, if a child is playing around and having the neck to get in between the two pull cords, there will be a high risk of strangulation. Therefore, conventional pull cord equalizer buckles are not highly safety in use.

### SUMMARY OF THE INVENTION

The present invention has been accomplished under the circumstances in view. It is the main object of the present to provide a pull cord equalizer buckle for window blind, which enhances application safety.

To achieve this and other objects of the present invention, a pull cord equalizer buckle comprises a first equalizer buckle member and a second equalizer buckle member. The first equalizer buckle member comprises a first peripheral wall, a first top wall connected to a top edge of the first peripheral wall, a first cord-escape hole located at the first top wall and defining a first close end and a first open end, a first bottom wall connected to an opposing bottom edge of the first peripheral wall, a first engagement wall extended from an inner surface of the first peripheral wall between the first top wall and the first bottom wall, a first cord-retaining slot located at the first engagement wall, and at least one engagement recess located at the first engagement wall near the first cord-retaining slot. The second equalizer buckle member is abutted to the first peripheral wall of the first equalizer buckle member, comprising a second peripheral wall, a second top wall connected to a top edge of the second peripheral wall, a second cord-escape hole located at the second top wall and defining a second close end and a second open end that is abutted against the first open end of the first cord-escape hole of the first equalizer buckle, a second bottom wall connected to an opposing bottom edge of the second peripheral wall, a second engagement wall extended from an inner surface of the second peripheral wall between the second top wall and the second bottom wall, a second cord-retaining slot located at the second engagement wall and kept in communication with the first cord-retaining slot of the first equalizer buckle, and at least one engagement protrusion located at the second engagement wall near the second cord-retaining slot and respectively detachably engaged with the at least one engagement recess at the first engagement wall of the first equalizer buckle member.

Thus, in application, two pull cords are respectively inserted through the cord-escape hole of the first equalizer buckle member and the second cord-escape hole of the second equalizer buckle and respectively retained in the first cord-retaining slot of the first equalizer buckle member and the second cord-retaining slot of the second equalizer buckle. If an external object gets in between the two pull cords, these two pull cords will be forced to push the first equalizer buckle member and the second equalizer buckle member outwards in reversed direction, and the first equalizer buckle member and the second equalizer buckle member will be forced apart from each other and released from the pull cords if the pressure imparted by the pull cords is larger than the binding force between the two equalizer buckle members, ensuring application safety.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a pull cord equalizer buckle for window blind in accordance with the present invention.

FIG. 2 is an exploded view of the pull cord equalizer buckle for window blind in accordance with the present invention.

FIG. 3 is a sectional assembly view of the pull cord equalizer buckle for window blind in accordance with the present invention.

FIG. 4 is a sectional applied view of the present invention, illustrating two upper pull cords and one lower pull cords fastened to the pull cord equalizer buckle.

FIG. 5 is a schematic drawing illustrating an external object got in between the two upper pull cords and the two upper pull cords respectively forced toward the close ends of the respective cord-escape holes.

FIG. 6 is a top view of the present invention, illustrating the two upper pull cords respectively moved to the close ends of the respective cord-escape holes.

FIG. 7 is a schematic sectional view of the present invention, illustrating the first equalizer buckle member and the second equalizer buckle member forced apart and released from the upper pull cords.

### DETAILED DESCRIPTION OF THE INVENTION

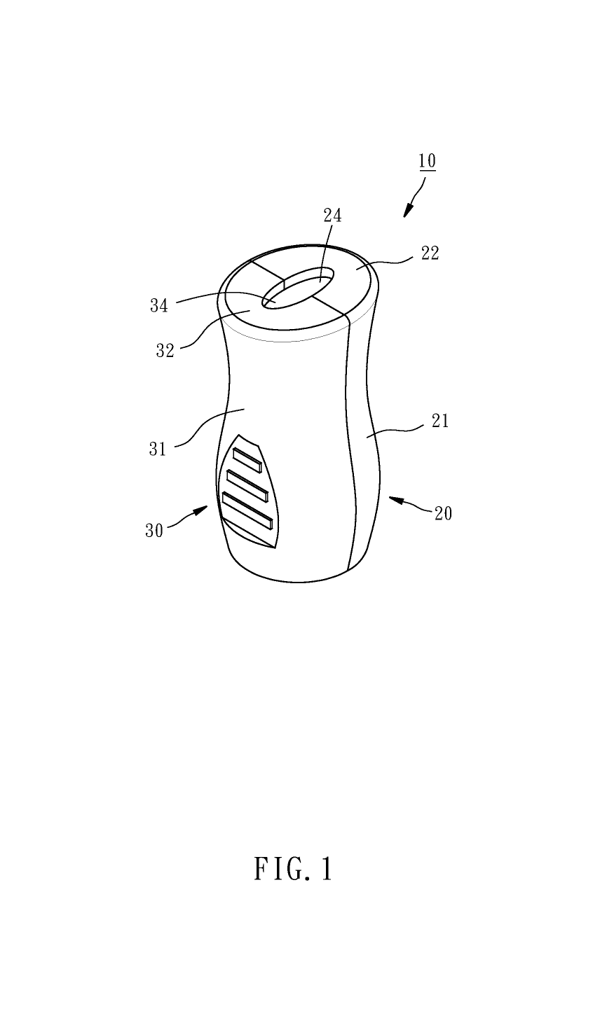

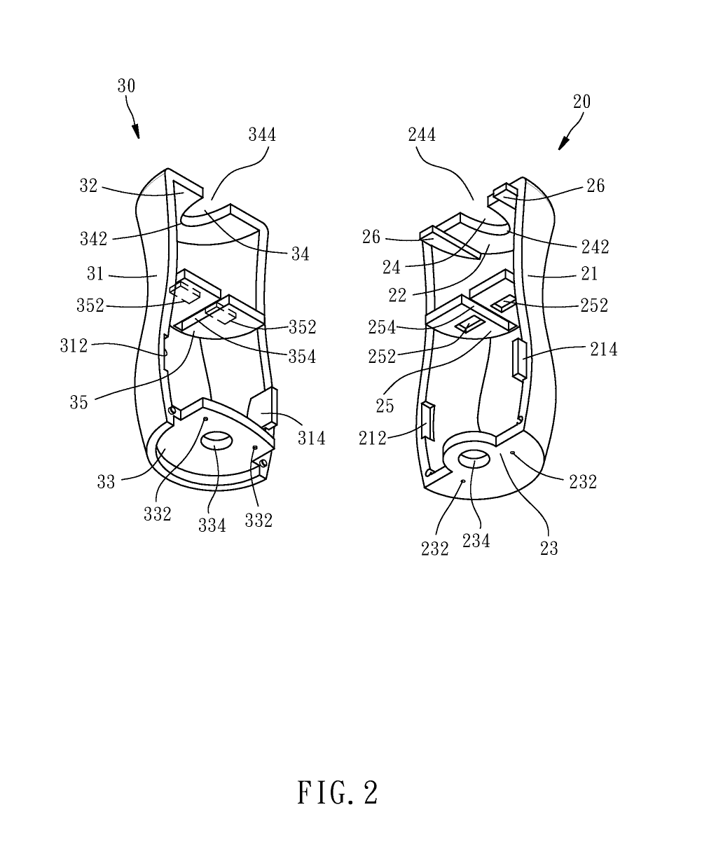

Referring to FIG. 1 and FIG. 2, a pull cord equalizer buckle 10 in accordance with the present invention is shown. The pull cord equalizer buckle 10 comprises a first equalizer buckle member 20 and a second equalizer buckle member 30.

The first equalizer buckle member 20 comprises a first peripheral wall 21, a first top wall 22 connected to a top edge of the first peripheral wall 21, a first bottom wall 23 connected to an opposing bottom edge of the first peripheral wall 21, a first mounting recessed portion 212 and a first mounting protruding portion 214 respectively located at two opposite lateral sides of the peripheral wall 21, a first cord-escape hole 24 with a semielliptical shape located at the first top wall 22 and defining a first close end 242 and a first open end 244, two locating recessed holes 232 located at a bottom surface of the first bottom wall 23, a first cord insertion hole 234 cut through opposing top and bottom surfaces of the first bottom wall 23 and equally spaced between the two locating recessed holes 232, a first engagement wall 25 extended from an inner surface of the first peripheral wall 21 and defining therein two engagement recesses 252 and a first cord-retaining slot 254 between the two engagement recesses 252, and two holding-down walls 26 bilaterally extended from the inner surface of the peripheral wall 21 near a top side thereof.

The second equalizer buckle member 30 comprises a second peripheral wall 31, a second top wall 32 connected to a top edge of the second peripheral wall 31, a second bottom wall 33 connected to an opposing bottom edge of the second peripheral wall 31, a second mounting recessed portion 312 and a second mounting protruding portion 314 respectively located at two opposite lateral sides of the second peripheral wall 31, a second cord-escape hole 34 with a semielliptical shape located at the second top wall 32 and defining a second close end 342 and a second open end 344, two locating protrusions 332 located at a bottom surface of the second bottom wall 33, a second cord insertion hole 334 cut through opposing top and bottom surfaces of the second bottom wall 33 and equally spaced between the two locating protrusions 332, and a second engagement wall 35 extended from an inner surface of the second peripheral wall 31 and defining therein two engagement protrusions 352 and a first cord-retaining slot 354 between the two engagement recesses 252.

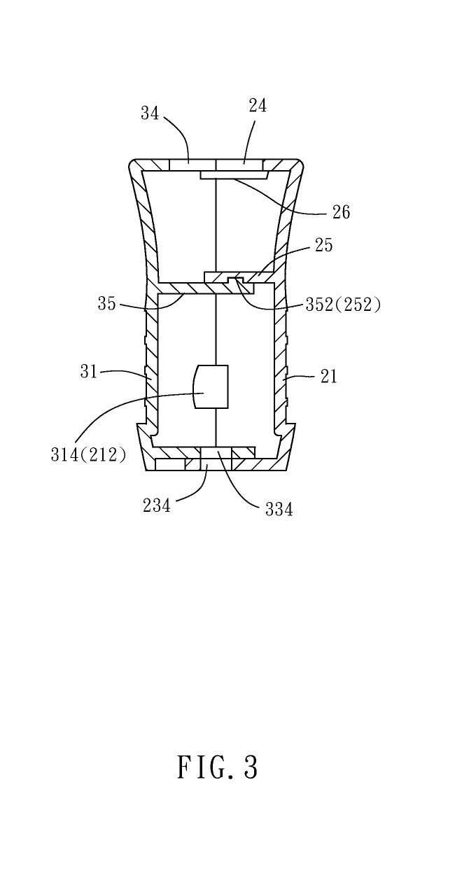

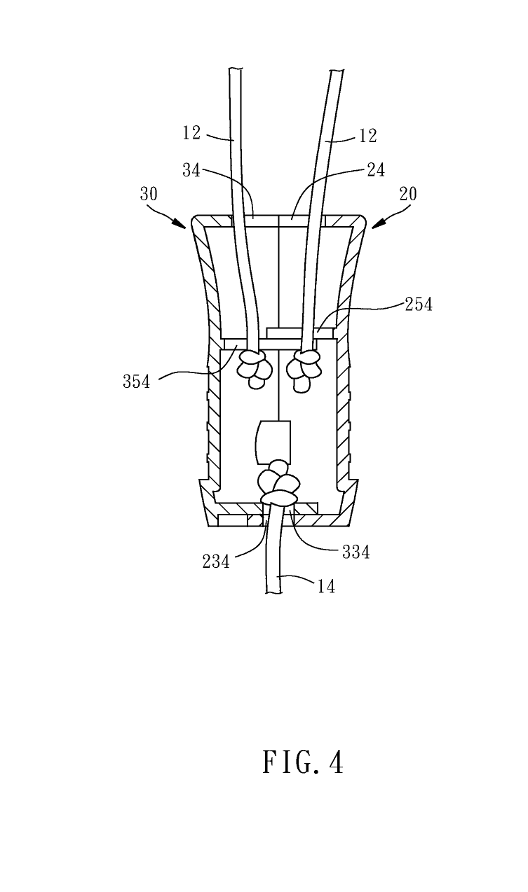

In installation, as shown in FIG. 3, attach the first mounting recessed portion 212 at the first peripheral wall 21 of the first equalizer buckle member 20 to the second mounting protruding portion 314 at the second peripheral wall 31 of the second equalizer buckle member 30 and the first mounting protruding portion 214 at the first peripheral wall 21 of the first equalizer buckle member 20 to the second mounting recessed portion 312 at the second peripheral wall 31 of the second equalizer buckle member 30, enabling the engagement recesses 252 at the first engagement wall 25 of the first equalizer buckle member 20 to be forced into engagement with the respective engagement protrusions 352 at the second engagement wall 35 of the second equalizer buckle member 30, the locating recessed holes 232 at the first bottom wall 23 of the first equalizer buckle member 20 to be forced into engagement with the respective locating protrusions 332 at the second bottom wall 33 of the second equalizer buckle member 30 and the holding-down walls 26 of the first equalizer buckle member 20 to be abutted against the inner surface the second peripheral wall 31 of the second equalizer buckle member 30. After the pull cord equalizer buckle 10 is assembled, the first open end 244 of the first cord-escape hole 24 of the first equalizer buckle member 20 is abutted against the second open end 344 of the second cord-escape hole 34 of the second equalizer buckle member 30, as shown in FIG. 1, the first cord-retaining slot 254 of the first engagement wall 25 of the first equalizer buckle member 20 is kept in communication with the second cord-retaining slot 354 of the second engagement wall 35 of the second equalizer buckle member 30, as shown in FIG. 4. Further, two upper pull cords 12 are respectively inserted through the first and second cord-escape holes 23,34 and the first and second cord-retaining slots 254,354 of the first and second equalizer buckle members 20,30, enabling the ends of these two upper pull cords 12 to be secured to the first and second engagement walls 25,35 of the first and second equalizer buckle members 20,30. Further, as illustrated in FIG. 4, the first cord insertion hole 234 at the first bottom wall 23 of the first equalizer buckle member 20 is kept in alignment and communication with the second cord insertion hole 334 at the second bottom wall 33 of the second equalizer buckle member 30. Further, a lower pull cord 14 is upwardly inserted through the first and second cord insertion holes 234,334 and then tied up into a knot so that the first equalizer buckle member 20 and the second equalizer buckle member 30 are kept together either they are fastened together or unfastened from each other.

In normal application, as illustrated in FIG. 4, the user can pull the lower pull cord 14, enabling the lower pull cord 14 to drag the pull cord equalizer buckle 10 subject to the linking relationship between the lower pull cord 14 and the pull cord equalizer buckle 10. At this time, the pull cord equalizer buckle 10 and the upper pull cords 12 are maintained in the retained relationship, and therefore, the upper pull cords 12 are driven to extend out or receive the window blind as the pull cord equalizer buckle 10 is being dragged by the lower pull cord 14.

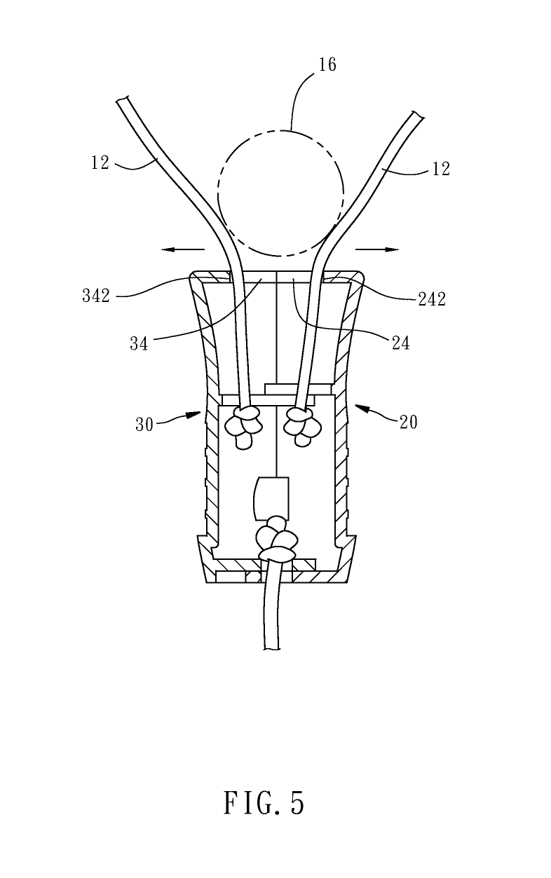

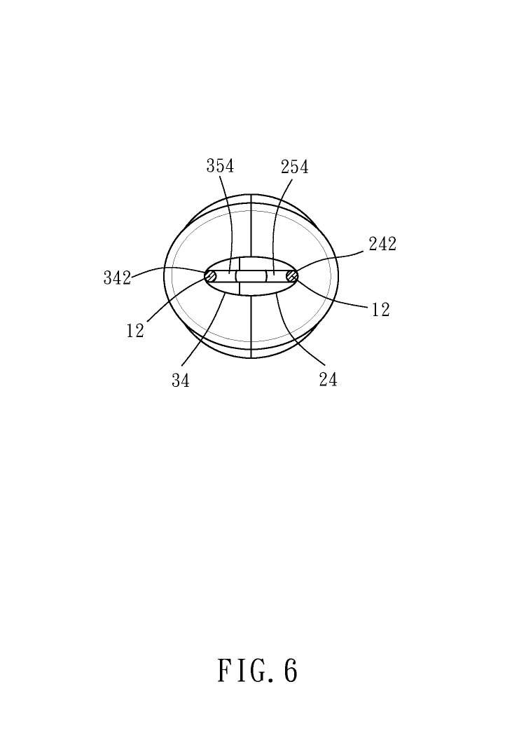

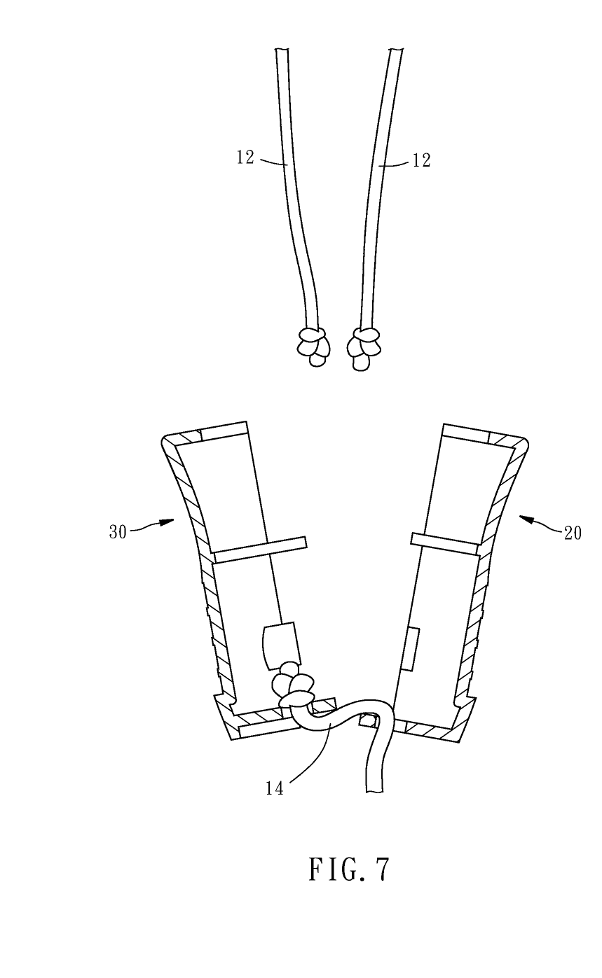

If an external object 16 (for example, the neck of a child) gets in between the two upper pull cords 12, as illustrated in FIGS. 5 and 6, these two upper pull cords 12 will be forced by the external object 16 to move to the first close end 242 of the first cord-escape hole 24 of the first equalizer buckle member 20 and the second close end 342 of the second cord-escape hole 34 of the second equalizer buckle member 30 and to further impart an outward pressure to the first close end 242 of the first cord-escape hole 24 of the first equalizer buckle member 20 and the second close end 342 of the second cord-escape hole 34 of the second equalizer buckle member 30 respectively. If the force imparted by the upper pull cords 12 to the first close end 242 of the first cord-escape hole 24 of the first equalizer buckle member 20 and the second close end 342 of the second cord-escape hole 34 of the second equalizer buckle member 30 is larger than the binding force between the first equalizer buckle member 20 and the second equalizer buckle member 30, as shown in FIG. 7, the first equalizer buckle member 20 and the second equalizer buckle member 30 will be forced apart and released from the upper pull cords 12, avoiding the risk of strangulation and achieving application safety.

What is claimed is:

1. A pull cord equalizer buckle used in a window blind, comprising:
a first equalizer buckle member comprising a first peripheral wall, a first top wall connected to a top edge of said first peripheral wall, a first cord-escape hole located at said first top wall and defining a first close end and a first open end, a first bottom wall connected to an opposing bottom edge of said first peripheral wall, a first engagement wall extended from an inner surface of said first peripheral wall between said first top wall and said first bottom wall, a first cord-retaining slot located at said first engagement wall, and at least one engagement recess located at said first engagement wall near said first cord-retaining slot; and
a second equalizer buckle member abutted to said first peripheral wall of said first equalizer buckle member, said second equalizer buckle member comprising a second peripheral wall, a second top wall connected to a top edge of said second peripheral wall, a second cord-escape hole located at said second top wall and defining a second close end and a second open end, a second bottom wall connected to an opposing bottom edge of said second peripheral wall, a second engagement wall extended from an inner surface of said second peripheral wall between said second top wall and said second bottom wall, a second cord-retaining slot located at said second engagement wall, and at least one engagement protrusion located at said second engagement wall near said second cord-retaining slot;
wherein said first open end of said first cord-escape hole of said first equalizer buckle member is abutted against said second open end of said second cord-escape hole of said second equalizer buckle member; said first cord-retaining slot at said first engagement wall of said first equalizer buckle member is kept in communication with said second cord-retaining slot at said second engagement wall of said second equalizer buckle member; said at least one engagement recess at said first engagement wall of said first equalizer buckle member is respectively and detachably engaged with said at least one engagement protrusion at said second engagement wall of said second equalizer buckle member.

2. The pull cord equalizer buckle as claimed in claim 1, wherein said first equalizer buckle member further comprises at least one locating recessed hole located at said first bottom wall; said second pull cord equalizer buckle member further comprises at least one locating protrusion located at said second bottom wall and detachably engaged with said at least one locating recessed hole of said first equalizer buckle member.

3. The pull cord equalizer buckle as claimed in claim 1, wherein said first equalizer buckle member further comprises a first cord insertion hole located at said first bottom wall; said second pull cord equalizer buckle member further comprises a second cord insertion hole located at said second bottom wall and disposed in communication with said first cord insertion hole.

4. The pull cord equalizer buckle as claimed in claim 1, wherein said first equalizer buckle member further comprises two holding-down walls bilaterally extended from an inner surface said first peripheral wall and stopped against an inner surface of said second peripheral wall of said second pull cord equalizer buckle member.

5. The pull cord equalizer buckle as claimed in claim 1, wherein said first equalizer buckle member further comprises a first mounting recessed portion and a first mounting protruding portion bilaterally located at said first peripheral wall; said second pull cord equalizer buckle further comprises a second mounting recessed portion and a second mounting protruding portion bilaterally located at said second peripheral wall and respectively detachably fastened to said located at said second bottom wall and disposed in communication with said first mounting protruding portion and said first mounting recessed portion of said first equalizer buckle member.
